(19) United States
(12) Patent Application Publication
(10) Pub. No.: US 2011/0030558 A1
(43) Pub. Date: Feb. 10, 2011

(54) DUST COLLECTOR, FILTRATION ARRANGMENT, AND METHODS

(76) Inventor: Thomas D. Raether, St. Louis Park, MN (US)

Correspondence Address: MERCHANT & GOULD PC, P.O. BOX 2903, MINNEAPOLIS, MN, 55402-0903, US

(21) Appl. No.: 12/863,895

(22) PCT Filed: Feb. 4, 2009
(86) PCT No.: PCT/US09/33061

§ 371 Date: Oct. 11, 2010

Related U.S. Application Data
(60) Provisional application No. 61/026,236, filed on Feb. 5, 2008.

(51) Int. Cl. B01D 50/00; B01D 46/00

(52) U.S. Cl. 95/273; 55/423; 55/368; 55/327; 55/321

(57) ABSTRACT

A dust collector includes a collector housing and a filter arrangement. The collector housing includes a hopper and has walls defining an unfiltered air plenum, a filter region, a filtered air plenum, an air inlet, and an air outlet. The air inlet has a first dimension across a widest portion of the air inlet. A filter arrangement is operably positioned in the filter region of the collector housing. Unfiltered air flows through the air inlet, into the unfiltered air plenum, through the filter arrangement, into the filtered air plenum and out through the air outlet. The hopper is located under the filter region in a position to catch particulate matter that falls by gravity from the filter arrangement and the unfiltered air plenum. The unfiltered air plenum includes a pre-separation region that is spaced both laterally and axially relative to the filter region. The pre-separation region is spaced laterally relative to the filter region at least 0.5 times the first dimension of the air inlet. The air inlet is spaced axially relative to a lowest portion of the filter region in a range of not greater than one time the first dimension of the air inlet. Methods of filtration include directing air to be filtered through an air inlet of a dust collector housing and into an unfiltered air plenum; directing at least some of the air into a pre-separation region of the housing; turning at least some of the air 180 degrees within the pre-separation region; directing the air through a filter arrangement and into a filtered air plenum; and directing filtered air out of the housing and through an air outlet.

This application is being filed on 4 Feb. 2009, as a PCT International patent application in the name of Donaldson Company, Inc., a U.S. national corporation, applicant for the designation of all countries except the US, and Thomas D. Raether, a citizen of the U.S., applicant for the designation of the US only, and claims priority to U.S. Provisional patent application Ser. No. 61/026,236, filed Feb. 5, 2008.

### TECHNICAL FIELD

This disclosure is directed to dust collectors. In particular, this disclosure is directed to improved arrangements in dust collectors, methods of filtration, and methods of using dust collectors.

### BACKGROUND

Dust collectors are used in factories, various industrial settings, and other environments in which more than a desirable amount of particulate material is floating in the air. For example, such particulate material can include dust or dirt and also, for example, materials such as flour, and other materials used in food processing.

Typical dust collectors can be embodied in the form of housings that hold several filter elements, the filter elements being in the form of cloth bags or tubular elements of pleated media. In typical use, after a period of use, the filter elements are cleaned while still operably installed in the dust collector. For example, in arrangements that use cloth bags, the bags may be vibrated or shaken to cause some of the dust to be knocked off of the exterior of the bags. In tubular filter elements, these elements are often pulsed with compressed air from the clean side to the dirty side. This pulse of compressed air helps to dislodge dust caked on the upstream side of the element.

Typical dust collectors have a dust collection hopper positioned underneath the filters. There is also an air inlet and a clean air outlet. Typical dust collectors will have the air inlet located coming into the hopper. Improvements in dust collectors are desired.

### SUMMARY OF THE DISCLOSURE

To address the problems of prior art dust collectors, an improved dust collector is provided including a collector housing and a filter arrangement. The collector housing includes a hopper and has walls defining an unfiltered air plenum, a filter region, a filtered air plenum, an air inlet, and an air outlet. The air inlet has a first dimension across a widest portion of the air inlet. A filter arrangement is operably positioned in the filter region of the collector housing. Unfiltered air flows through the air inlet, into the unfiltered air plenum, through the filter arrangement, into the filtered air plenum and out through the air outlet. The hopper is located under the filter region in a position to catch particulate matter that falls by gravity from the filter arrangement and the unfiltered air plenum. The unfiltered air plenum includes a pre-separation region that is spaced both laterally and axially relative to the filter region. The pre-separation region is spaced laterally relative to the filter region at least 0.5 times the first dimension of the air inlet. The air inlet is spaced axially relative to a lowest portion of the filter region in a range of not greater than one time the first dimension of the air inlet.

In another aspect, the method of filtration is provided. The method includes directing air to be filtered through an air inlet of a dust collector housing and into an unfiltered air plenum. Next, the method includes directing at least some of the air into a pre-separation region of the housing. Next, the method includes turning at least some of the air 180 degrees within the pre-separation region. Next, the method includes directing the air through a filter arrangement and into a filtered air plenum. Next, the method includes directing filtered air out of the housing and through an air outlet.

Not all the features described herein must be incorporated in an arrangement for the arrangement to have some selected advantage, according to the present disclosure.

### BRIEF DESCRIPTION OF THE DRAWINGS

FIG. 1 is a schematic side-elevational view of a first embodiment of a dust collector constructed according to principles of this disclosure;

FIG. 2 is another schematic side-elevational view of the dust collector of FIG. 1, and showing the use of a different filter arrangement than the arrangement of FIG. 1;

FIG. 3 is another side-elevational view of the dust collector of FIGS. 1 and 2 and showing another use of filter arrangements;

FIG. 4 is a side-elevational view of the dust collector of FIGS. 1-3 and showing the use of deflectors in the dust collector;

FIG. 5 is a schematic side-elevational view of the dust collector of FIGS. 1-4 and showing another variation of the use of deflectors within the use of dust collector;

FIG. 6 is a schematic side-elevational view of another embodiment of the dust collector constructed according to principles of this disclosure; and

FIG. 7 is a schematic side-elevational view of the dust collector of FIG. 6 and showing a variation in the use of deflectors within the dust collector.

### DETAILED DESCRIPTION

### A. Problems with Existing Arrangements

Existing arrangements that utilize cloth bags or tubular filter elements can occupy a large volume of space in the unfiltered air plenum of dust collectors. By using panel filters, the panel filters do not intrude significantly into the unfiltered air volume of the dust collector. The advantage is that the volume of the unfiltered air plenum can be significantly reduced in height, depth, and volume. However, problems include: distribution of incoming air flow and dust or particulate material without adding devices into the unfiltered air plenum; reduction (or elimination) of high velocity of flow in the unfiltered air plenum; and creation of a flow pattern of desirable velocity that will aid in deposition of dust or particulate into the hopper and reduce the dust and particulate material flowing into the filter. High velocity in the dust hopper tends to cause re-entrainment of the dust into the air flow and then into the filter arrangement, which causes the life of the filter arrangement to be less than optimal.

In many typical arrangements, dust collectors will connect the incoming unfiltered air flow inlet directly into the hopper. The inventor has recognized that there are problems with this method including, for example, all air flow is directed up toward the filter arrangements resulting in dust and particulate being directed toward the filter arrangement; air flow is poorly distributed; and there are high velocity regions that have significant dust-carrying capacity, which shortens filter life. Hopper inlet deflectors can be utilized to lessen these effects, but their added cost can increase hopper velocities and present surfaces that materials can settle or build upon. Dust collectors can utilize side flow methods, but this will only work in conjunction with utilizing deflectors or other types of devices to help better distribute flow and dust and particulate. In addition, deflectors reduce the cross-sectional area, which has two immediate results: (i) this creates high velocity regions that carry into the unfiltered air plenum; and (ii) this creates a system loss, which is an increase in system differential pressure. Furthermore, deflectors are an added cost and are surfaces that can collect dust and particulate. Eventual clogging of significant portions of deflectors are common, which can shorten the life of systems.

The inventor has recognized that one solution to using side inlets and hopper inlets is to locate the inlet high on the side of the unfiltered air plenum. This potential solution is not as helpful for cloth bags, V-packs, or tubular cartridge filters because there will be a direct impingement of dust and particulate on the filter arrangement. While this will work for panel filter arrangements, there is still a problem recognized by the inventor that there are high velocities within the hopper. High velocities within the hopper causes re-entrainment of the dust and particulate from the hopper into the filters, which shortens filter life.

### B. Operation of the Overall Improved System

The inventor has recognized that by using a region of added volume in the path of the unfiltered air flow, the region will reduce the impact of high velocity particulate in this region of added volume. The region of added volume can be in the form of a bump or elbow in the collector housing.

In use, unfiltered air will flow into the dust collector and is directed into a pre-separation region. The pre-separation region in the embodiments shown is a region that extends beyond the filtration region and will turn the unfiltered air through a turn of about 180 degrees. The completed turn provides a lower velocity profile across the top of the hopper, whereby the dust can settle out of the air stream.

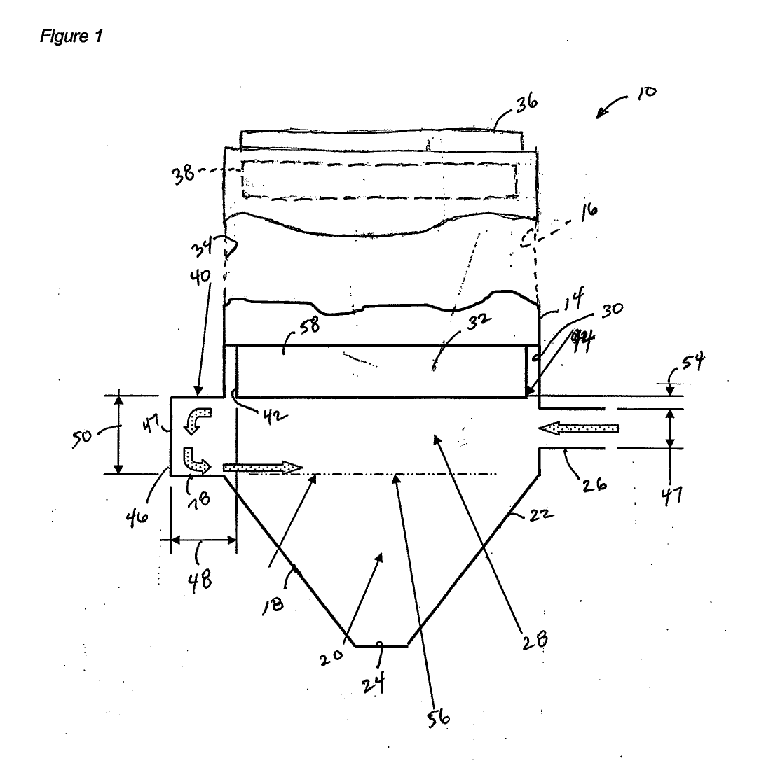

### C. The Embodiment of FIGS. 1-7

In reference to FIG. 1, a dust collector constructed according to principles of this disclosure is shown schematically at 10. In the embodiment shown, the dust collector 10 includes a collector housing 12. The collector housing 12 can be embodied in many different forms and will generally include a plurality of walls 14 that define an interior volume 16. In typical arrangements, the walls 14 form a rectangular enclosure, but other arrangements can be used.

The dust collector 10, in the example shown, includes a hopper 18. The hopper 18 defines a hopper volume 20 for collecting dust or other particulate material in the dust collector 10. In the embodiment shown in FIG. 1, the hopper 18 includes angled side walls 22 that angle toward each other in a downward direction. In other words, in the embodiment shown, the hopper side walls 22 form a structure similar to a truncated cone. This angled arrangement of the side walls 22 helps to direct dust and other particulate material in a funnel fashion from an area adjacent to the filtration area down to a collection area 24. In typical use, the hopper 18 can be emptied through the collection area 24 into waste collection bins for proper disposal.

The dust collector 10 further includes an unfiltered air inlet 26. The air inlet 26 allows an unfiltered air flow to enter dust collector housing 12. More details on the air inlet 26 are discussed below. The air inlet 26 directs the unfiltered air into an unfiltered air plenum 28. The unfiltered air plenum 28 is defined by the walls 14 of the collector housing 12, and it is the volume of air before it is directed though the filter arrangement. It is located generally above the hopper volume 20.

The collector housing 12 further defines a filter region 30 for operably holding a filter arrangement 32. The filter arrangement 32 can include an arrangement of filter elements for cleaning the air in the unfiltered air plenum 28. The filter arrangement 32 can include, for example, a panel filter or plurality of panel filters, filter elements, such as tubular cartridge filters, bags, such as cloth bags, or V-packs. Many different types of filters are usable. Tubular filter cartridges can be cylindrical elements, oval elements, and conical elements, for example.

The collector housing 12 further defines filtered air plenum 34. The filtered air plenum 34 is downstream of the filter arrangement 32. Air to be filtered flows the inlet 26, through the filter arrangement 32 in the filter region 30 and then into the filtered air plenum 34. From there, the air is directed through an air outlet 36 also defined by the collector housing 12.

The dust collector 10 may include a mechanism to direct air through the housing 12. Many different embodiments are usable, and in the embodiment illustrated, a blower 38 is shown schematically. The blower 38 includes a blower arrangement such as a fan, which directs unfiltered air through the air inlet 26, into the unfiltered air plenum 28, through the filter arrangement 32, into the filtered air plenum 34, and out through the air outlet 36.

The hopper 18 is located under the filter region 30 in a position to catch dust or other particulate material that falls by gravity from the filter arrangement 32 and from the unfiltered air plenum 28.

In accordance with principles of this disclosure, the dust collector 10 further includes a pre-separation region 40 as part of the unfiltered air plenum 28. The pre-separation region 40, in this embodiment, is spaced both laterally and axially relative to the filter region 30. By being spaced laterally, it is meant that it is spaced sideways and is beyond an outer edge 42 of the filter arrangement 32. By being spaced axially, it is meant that is below the bottom edge 44 of the filter arrangement 32. As can be seen in FIG. 1, the pre-separation region 40 is embodied as a bump-out region 46 defined by walls 14 of the housing 12. In one embodiment, the bump-out region 46 has the shape of a rectangular box with one wall removed providing gas flow communication with the unfiltered air plenum 28.

The pre-separation region 40 is constructed and arranged to receive at least some of the unfiltered air and turn at least some of that air about 180 degrees within the pre-separation region 40. This helps to slow the velocity of the air in the unfiltered air plenum to be below 2000 feet per minute (ft/min or fpm), preferably under 1500 ft/min. In addition, this helps to lower the velocity in the hopper volume 20 to be less than 500 ft/min, preferably less than 250 ft/min. Locations and sizes of the pre-separation region 40 can be selected to result in these lowered velocities. The size and location can be related to other structural features of the dust collector housing 12, including, for example, the air inlet 26.

The air inlet 26 has an opening size. The opening size has a dimension across a widest portion. For example, if the air inlet 26 is circular, this first dimension is a diameter. However, it is recognized that air inlets come in a variety of shapes including oval or rectangular, and the first dimension would be the widest of these shapes. The pre-separation region 40 is spaced laterally relative to the filter region 30 at least 0.5 times the first dimension of the air inlet 26. It may also be spaced laterally up to three times the first dimension of the air inlet 26. Preferably, the pre-separation region 40 is spaced laterally relative to the filter region 30 about equal to (one time) the first dimension of the air inlet 26. This lateral spacing is shown at dimension 48 in FIG. 1.

The pre-separation region 40 includes a height, shown at dimension 50 in FIG. 1. The height 50 is generally the dimension vertically from the region adjacent to the bottom edge 44 of the filter region 30 in a direction in a hopper 18. The height 50 of the pre-separation region 40 will be at least 0.5 times the first dimension 47 of the air inlet 26. The height 50 can be up to four times the first dimension 50. In preferred embodiments, the height 50 will be two times the first dimension 47 of the inlet 26. In certain arrangements, it is also helpful to have the air inlet 26 located relative to the filter region 30 to achieve the improved results. In the embodiment shown in FIG. 1, the air inlet 26 is depicted as being spaced an axial distance 54 relative to the bottom edge 44 of the filter region 30. The air inlet 26 is spaced axially relative to a lowest portion of the filter region 44 in a range of not greater than one time the first dimension 47 of the air inlet 26. In preferred embodiments, the distance 54 will be zero; that is, the top of the air inlet 26 will be even with the bottom 44 of the filter arrangement 32. In use, the distance 54 will be from 0 to one time the first dimension 47.

In operation, air to be filtered is directed through the air inlet 26. The air flow enters the unfiltered air plenum 28. At least some of the unfiltered air flows into the bump-out region 46 or pre-separation region 40, where it turns in an opposite direction, about 180 degrees. This turning helps to slow down the velocity of the particulate in the unfiltered air and of the unfiltered air. Region 40 and end wall 47 provide a means to change the airflow to a direction nearly parallel to the plane defined as region 56, which helps to prevent sweeping of the hopper (re-entrainment of dust). Region 56 shows the approximate boundary of the top of the hopper 18 and which is also the low velocity dust drop out region. The particulate enters region 40 and possibly impacts wall 47; both effectively lowering the velocity of the particulate. Useful velocities in region 56 are 500 ft/min or lower, preferably 250 ft/min or lower. Because of the lowered velocity, certain of the dust and particulate matter will drop by gravity into the hopper volume 20. The unfiltered air then flows from the unfiltered air plenum 28 through the filtered arrangement 32 and into the filtered air plenum 34. From there, the filtered air is directed or exhausted through the air outlet 36.

In the embodiment shown, in FIG. 1, the filtered arrangement 32 is a panel filter 38. The panel filter 38 can include a single panel filter or a plurality of individual panel filters. The panel filters can be pleated media; Z-media; or depth media, for example. By Z-media, it is meant media formed with a plurality of flutes in which alternating flute ends are closed. Examples of such Z-media is described in, for example, U.S. Pat. Nos. 6,350,291; 6,966,940; US 2006-0163150; and PCT 2006/017790; each of these patents being incorporated by reference herein.

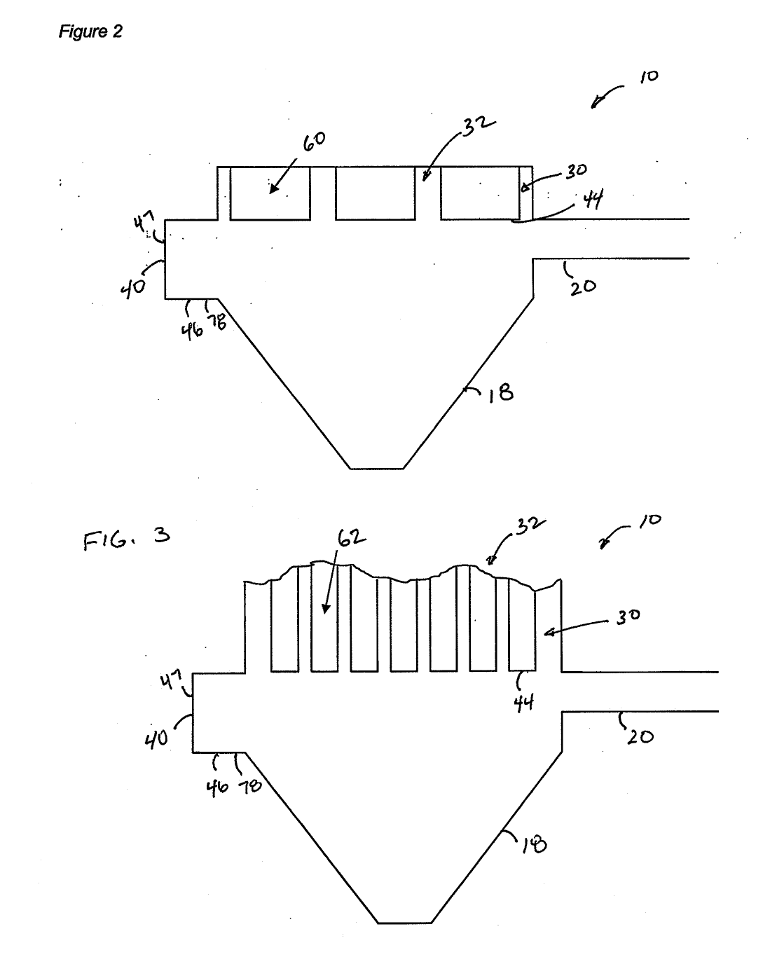

In FIG. 2, the dust collector 10 is shown with cartridge filters 60. Cartridge filters 60 can include tubular filter elements, such as cylindrical, oval or conical style filter cartridges 60. The media can be, for example, pleated media. In FIG. 2, the filter arrangement 32 includes a plurality of the cartridge filters 60.

In FIG. 3, the dust collector 10 is shown holding as the filter arrangement 32 a plurality of fabric or pleated bag filters 62. The pleated or fabric bag filters 62 are located in the filter region 30.

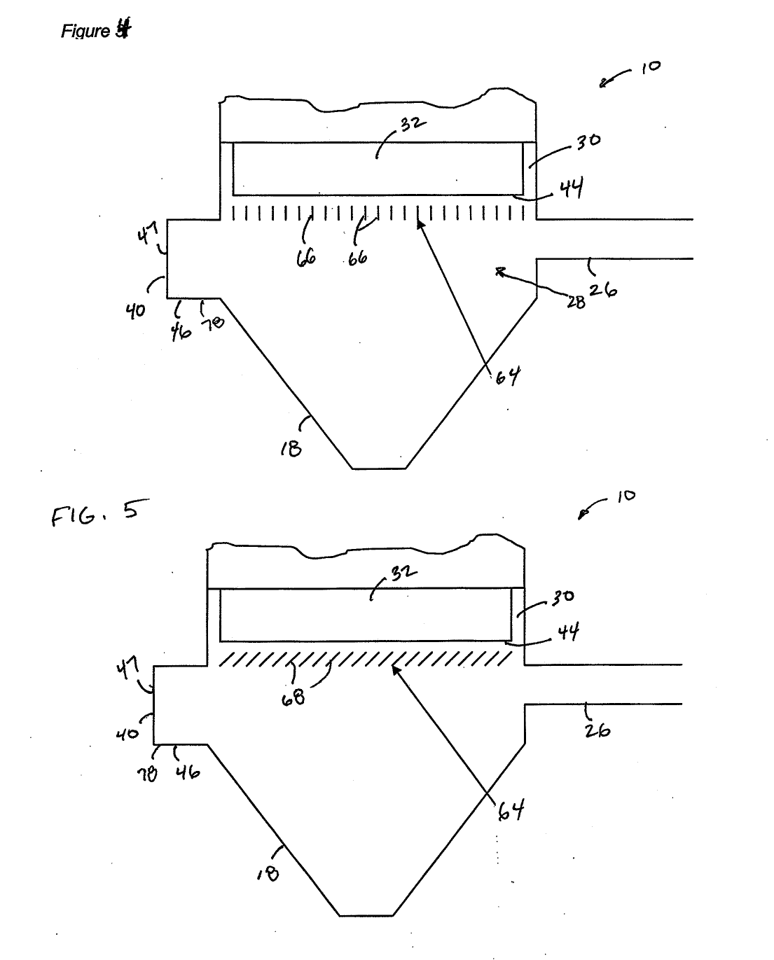

FIG. 4 depicts the dust collector 10 and further includes a deflector arrangement 64. In general, the deflector arrangement 64 is positioned in the unfiltered air plenum 28 axially below the filter arrangement 32 in the filter region 30. In general, the deflector arrangement 64 helps to further slow down air flow velocity in the unfiltered air plenum 28. In the embodiment shown in FIG. 4, the deflector arrangement 64 includes a plurality of individual deflector fins 66. The fins 66, in the embodiment shown, are generally parallel to a vertical axis, in that they extend generally straight up and down vertically.

In the embodiment of FIG. 5, the deflector arrangement 64 includes fins 68 that are angled from a vertical axis. Also depicted in FIG. 5, it is shown that in this embodiment, the fins 68 are each generally parallel to each other, and are shown at an angle of between 20 degrees-60 degrees from a vertical axis. Of course, many

variations in deflector arrangements are usable and contemplated. These are only depicted examples.

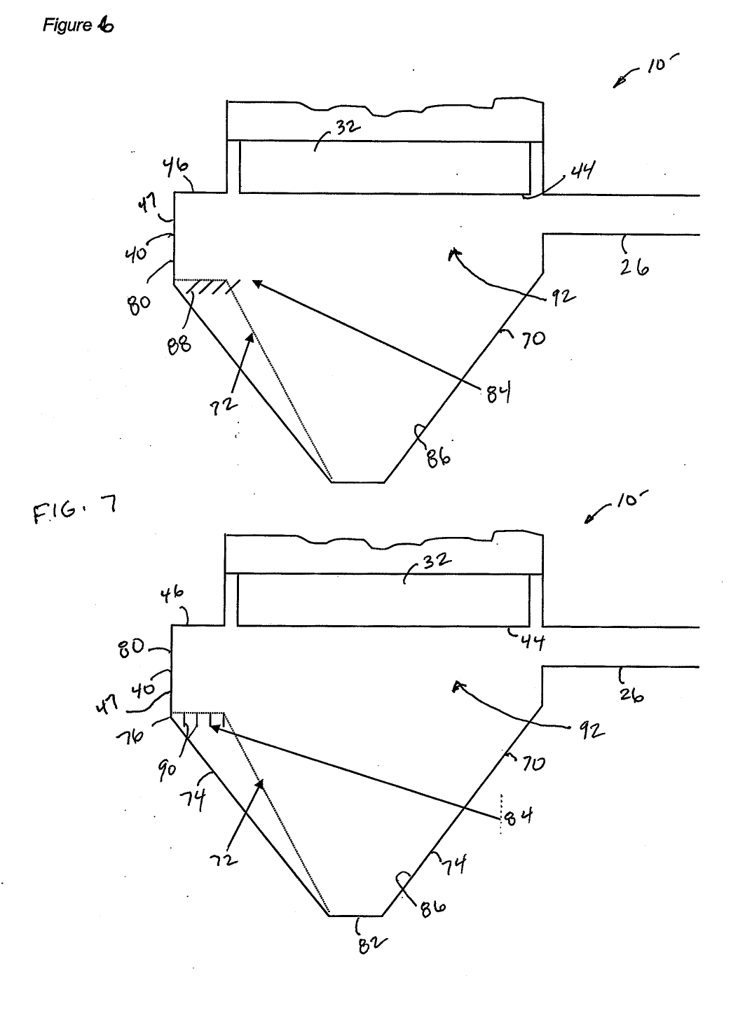

FIG. 6 shows another embodiment of a dust collector at 10′. Dust collector 10′ has an expanded hopper 70. In hidden lines at 72, the hopper construction of FIGS. 1-5 can be seen. As can be appreciated, the hopper 70 includes angled side walls 74. In this embodiment, the pre-separation region 40 has at a bottom edge 76, rather than an inwardly extending wall such as wall 78 in FIGS. 1-5, one of the side walls 74 of the hopper extends directly from the outermost wall 80 down to the collection area 82.

Still in reference to the embodiments of FIGS. 6 and 7, the dust collector 10′ includes in these embodiments, a pre-separation deflector arrangement 84 located below the pre-separation region 40 and extending into the hopper volume 86. In the embodiment of FIG. 6, the deflector arrangement 84 includes a plurality of fins 88 that are angled from a vertical axis in a direction pointing toward the filter arrangement 32. In the embodiment of FIG. 7, the deflector arrangement 84 includes fins 90 that are parallel to a vertical axis. Of course, many embodiments and arrangements of deflectors can be used. The embodiments of FIGS. 6 and 7 are only examples that are depicted. The deflector arrangement 84 aids in slowing down the velocity of the air in the unfiltered air plenum 92.

Methods of filtration can be employed using arrangements as described herein. For example, one method can include directing air to be filtered through an air inlet of a dust collector housing and into an unfiltered air plenum; then directing at least some of the air into a pre-separation region of the housing; then turning at least some of the air 180 degrees within the pre-separation region; then directing the air through a filter arrangement and into a filtered air plenum; and then directing filtered air out of the housing through an air outlet.

The step of directing air through an air inlet preferably includes directing the air through inlet that has a first dimension across the widest portion of the air inlet, and the air inlet is spaced axially relative to a lowest portion of the filter arrangement in a range not greater than one time the first dimension of the air inlet. Preferably, the air inlet will be even with a lowest portion of the filter arrangement.

The step of directing at least some of the air into a pre-separation region of the housing includes directing at least some of the air into a pre-separation region that is spaced both laterally and axially relative to the filter arrangement. The pre-separation region is spaced laterally relative to the filter region at least 0.5 times the first dimension of the air inlet. Preferably, pre-separation region is spaced laterally relative to the filter region no greater than three times the first dimension of the air inlet.

The step of directing the air through a filter arrangement includes directing through an arrangement of at least one of panel filters, cylindrical filters, oval filters, conical filters, and bag filters. Particulate material is collected in a hopper located below the unfiltered air plenum and the filter arrangement.

In use, preferably practicing this method will result in velocity of the air flow in the hopper to be under 500 ft/min. Preferably, practicing this method will result in a velocity of the air flow in the unfiltered air plenum to be under 2000 ft/min.

### General Principles and Examples

In general, a dust collector may be provided. The collector can include a collector housing, which may include a hopper having walls defining an unfiltered air plenum, a filter region, a filtered air plenum, an air inlet, and an air outlet. The air inlet can have a first dimension across a widest portion of the air inlet. A filter arrangement may be operably positioned in the filter region, and the hopper can be located under the filter region in a position to catch particulate matter that falls by gravity from the filter arrangement and the unfiltered air plenum. The unfiltered air plenum may include a pre-separation region that may be spaced both laterally and axially relative to the filter region. The pre-separation region may be spaced laterally relative to the filter region at least 0.5 times the first dimension of the air inlet; and the air inlet may be spaced axially relative to a lowest portion of the filter region in a range of not greater than 1 time the first dimension of the air inlet.

The hopper can include angled sidewalls angling toward each other in a downward direction; and the pre-separation region may be located axially between the angled sidewalls of the hopper and the filter region.

The pre-separation region can have a height of at least 0.5 times the first dimension of the air inlet.

The pre-separation region can have a height of at 0.5-4 times the first dimension of the air inlet; and the pre-separation region may be spaced laterally relative to the filter region 0.5-3 times the first dimension of the air inlet.

The air inlet may be spaced axially relative to a lowest portion of the filter region in a range of even with the lowest portion of the filter region to not greater than 1 time the first dimension of the air inlet.

The air inlet may be circular and the first dimension may be a diameter.

The filter arrangement can include a plurality of one of panel filters; cylindrical filters; oval filters; conical filters; and bag filters. 8. A deflector arrangement can be positioned in the collector in the unfiltered air plenum below the filter region and axially between the pre-separation region and the filter region.

The deflector arrangement can include a plurality of deflectors angled from a vertical axis.

The deflector arrangement can include a plurality of deflectors parallel to a vertical axis.

A pre-separation deflector arrangement can be located below the pre-separation region and extend into the hopper.

The pre-separation deflector arrangement can include a plurality of deflectors angled from a vertical axis.

The pre-separation deflector arrangement can include a plurality of deflectors extending parallel to a vertical axis.

A blower can be provided constructed and arranged to direct unfiltered air through the air inlet, into the unfiltered air plenum, through the filter arrangement, into the filtered air plenum, and out through the air outlet.

A dust collector housing is provided that may include a hopper and having walls defining an unfiltered air plenum, a filter region, a filtered air plenum, an air inlet, and an air outlet; and wherein: the air inlet can have a first dimension across a widest portion of the air inlet; the hopper may be located under the filter region; the unfiltered air plenum can include a pre-separation region that may be spaced both laterally and axially relative to the filter region; the pre-separation region may be spaced laterally relative to the filter region at least 0.5 times the first dimension of the air inlet; and the air inlet may be spaced axially relative to a lowest portion of the filter region in a range of not greater than 1 time the first dimension of the air inlet.

The pre-separation region may be located axially between the hopper and the filter region.

The pre-separation region can have a height of at 0.5-4 times the first dimension of the air inlet; and the pre-separation region may be spaced laterally relative to the filter region 0.5-3 times the first dimension of the air inlet.

The air inlet may be spaced axially relative to a lowest portion of the filter region in a range of even with the lowest portion of the filter region to not greater than 1 time the first dimension of the air inlet.

The air inlet may be circular and the first dimension may be a diameter.

A deflector arrangement can be positioned in the collector in the unfiltered air plenum below the filter region and axially between the pre-separation region and the filter region.

A pre-separation deflector arrangement may be located below the pre-separation region and extending into the hopper; and a blower arrangement can be provided which is constructed and arranged to direct air through the housing.

A method of filtration may be provided including directing air to be filtered through an air inlet of a dust collector housing and into an unfiltered air plenum; then directing at least some of the air into a pre-separation region of the housing; turning the at least some of the air 180 degrees within the pre-separation region; then directing the air through a filter arrangement and into a filtered air plenum; and directing filtered air out of the housing through an air outlet.

The step of directing air through an air inlet can include directing the air through an air inlet that can have a first dimension across a widest portion of the air inlet, and the air inlet being spaced axially relative to a lowest portion of the filter arrangement in a range of not greater than 1 time the first dimension of the air inlet.

The step of directing at least some of the air into a pre-separation region of the housing can include directing at least some of the air into a pre-separation region that may be spaced both laterally and axially relative to the filter arrangement; the pre-separation region being spaced laterally relative to the filter region at least 0.5 times the first dimension of the air inlet.

The step of directing the air through a filter arrangement can include directing the air through an arrangement of at least one of panel filters, cylindrical filters, oval filters, conical filters, and bag filters.

The method may include collecting particulate material in a hopper located below the unfiltered air plenum and filter arrangement.

In the method, the velocity of the air flow in the hopper may be under 500 ft/min.

In the method, the velocity of the air flow in the unfiltered air plenum may be under 2000 ft/min.

Many embodiments can be made in accordance with principles described herein. Not all the features described herein must be incorporated in an arrangement for the arrangement to have some selected advantage, according to the present disclosure.

1-28. (canceled)

29. A dust collector comprising:
(a) a collector housing including a hopper and having walls defining an unfiltered air plenum, a filter region, a filtered air plenum, an air inlet, and an air outlet;
(i) the air inlet having a first dimension across a widest portion of the air inlet;
(b) a filter arrangement operably positioned in the filter region;
and wherein:
(i) the hopper is located under the filter region in a position to catch particulate matter that falls by gravity from the filter arrangement and the unfiltered air plenum;
(ii) the unfiltered air plenum includes a pre-separation region that is spaced both laterally and axially relative to the filter region;
(iii) the pre-separation region is spaced laterally relative to the filter region at least 0.5 times the first dimension of the air inlet; and
(iv) the air inlet is spaced axially relative to a lowest portion of the filter region in a range of not greater than 1 time the first dimension of the air inlet.

30. A dust collector according to claim 29 wherein:
(a) the hopper includes angled sidewalls angling toward each other in a downward direction; and
(b) the pre-separation region is located axially between the angled sidewalls of the hopper and the filter region.

31. A dust collector according to claim 29 wherein:
(a) the pre-separation region has a height of at least 0.5 times the first dimension of the air inlet.

32. A dust collector according to claim 29 wherein:
(a) the pre-separation region has a height of at 0.5-4 times the first dimension of the air inlet; and
(b) the pre-separation region is spaced laterally relative to the filter region 0.5-3 times the first dimension of the air inlet.

33. A dust collector according to claim 29 wherein:
(a) the air inlet is spaced axially relative to a lowest portion of the filter region in a range of even with the lowest portion of the filter region to not greater than 1 time the first dimension of the air inlet.

34. A dust collector according to claim 29 wherein:
(a) the air inlet is circular and the first dimension is a diameter.

35. A dust collector according to claim 29 wherein:
(a) the filter arrangement includes a plurality of one of panel filters; cylindrical filters; oval filters; conical filters; and bag filters.

36. A dust collector according to claim 29 further comprising:
(a) a deflector arrangement positioned in the collector in the unfiltered air plenum below the filter region and axially between the pre-separation region and the filter region.

37. A dust collector according to claim 36 wherein:
(a) the deflector arrangement includes a plurality of deflectors angled from a vertical axis.

38. A dust collector according to claim 36 wherein:
(a) the deflector arrangement includes a plurality of deflectors parallel to a vertical axis.

39. A dust collector according to claim 29 further comprising:
(a) a pre-separation deflector arrangement located below the pre-separation region and extending into the hopper.

40. A dust collector according to claim 39 wherein:
(a) the pre-separation deflector arrangement includes a plurality of deflectors angled from a vertical axis.

41. A dust collector according to claim 39 wherein:
(a) the pre-separation deflector arrangement includes a plurality of deflectors extending parallel to a vertical axis.

42. A dust collector according to claim 29 further including:
(a) a blower constructed and arranged to direct unfiltered air through the air inlet, into the unfiltered air plenum, through the filter arrangement, into the filtered air plenum, and out through the air outlet.

43. A dust collector housing comprising:
(a) a hopper and having walls defining an unfiltered air plenum, a filter region, a filtered air plenum, an air inlet, and an air outlet; and
wherein:
(i) the air inlet has a first dimension across a widest portion of the air inlet;
(ii) the hopper is located under the filter region;
(iii) the unfiltered air plenum includes a pre-separation region that is spaced both laterally and axially relative to the filter region;
(iv) the pre-separation region is spaced laterally relative to the filter region at least 0.5 times the first dimension of the air inlet; and
(v) the air inlet is spaced axially relative to a lowest portion of the filter region in a range of not greater than 1 time the first dimension of the air inlet.

44. A dust collector housing according to claim 43 wherein:
(a) the pre-separation region is located axially between the hopper and the filter region.

45. A dust collector housing according to claim 43 wherein:
(a) the pre-separation region has a height of at 0.5-4 times the first dimension of the air inlet; and
(b) the pre-separation region is spaced laterally relative to the filter region 0.5-3 times the first dimension of the air inlet.

46. A dust collector according to claim 43 wherein:
(a) the air inlet is spaced axially relative to a lowest portion of the filter region in a range of even with the lowest portion of the filter region to not greater than 1 time the first dimension of the air inlet;
(b) the air inlet is circular and the first dimension is a diameter; and
(c) a deflector arrangement is positioned in the collector in the unfiltered air plenum below the filter region and axially between the pre-separation region and the filter region.

47. A method of filtration using a dust collector; the method comprising:
(a) directing air to be filtered through an air inlet of a dust collector housing and into an unfiltered air plenum; then
(b) directing at least some of the air into a pre-separation region of the housing;
(c) turning the at least some of the air 180 degrees within the pre-separation region; then
(d) directing the air through a filter arrangement and into a filtered air plenum; and
(e) directing filtered air out of the housing through an air outlet.

48. A method according to claim 47 wherein:
(a) the step of directing air through an air inlet includes directing the air through an air inlet that has a first dimension across a widest portion of the air inlet, and the air inlet being spaced axially relative to a lowest portion of the filter arrangement in a range of not greater than 1 time the first dimension of the air inlet.
